(19) United States
(12) Patent Application Publication
(10) Pub. No.: US 2024/0063513 A1
(43) Pub. Date: Feb. 22, 2024

(54) Busbar Assembly and Battery Module Including the Same

(71) Applicant: SK On Co., Ltd., Seoul (KR)

(72) Inventors: Hoemin CHEONG, Daejeon (KR); Seul Gi LEE, Daejeon (KR); Hyeong Won KIM, Daejeon (KR); Ki Dong LEE, Daejeon (KR)

(21) Appl. No.: 18/363,051

(22) Filed: Aug. 1, 2023

(30) Foreign Application Priority Data
Aug. 16, 2022 (KR) 10-2022-0102026

(51) Int. Cl. H01M 50/507; H01M 50/516; H01M 50/211

(52) U.S. Cl. CPC H01M 50/507; H01M 50/516; H01M 50/211

(57) ABSTRACT

The busbar assembly of the present disclosure comprises a busbar plate electrically connected to electrode tabs of a plurality of battery cells; a busbar terminal electrically connected to an external device; and a welding portion electrically connecting the busbar plate and the busbar terminal with each other, wherein the welding portion is formed by butt welding between the busbar plate and the busbar terminal.

### CROSS-REFERENCE TO RELATED PATENT APPLICATION

The present application claims priority under 35 U.S.C. § 119(a) to Korean patent application number 10-2022-0102026 filed on Aug. 16, 2022, in the Korean Intellectual Property Office, the entire disclosure of which is incorporated by reference herein.

### BACKGROUND OF THE INVENTION

### 1. Field

The present disclosure relates to a secondary battery, specifically, to a busbar assembly and a battery module including the same.

### 2. Description of the Related Art

As an energy power source for driving various electronic devices such as smartphones, laptops, vehicles, and drones, demand for secondary batteries is rapidly increasing. In particular, as a secondary battery for driving a vehicle or the like, research on a battery module is actively conducted.

A battery module may comprise a plurality of battery cells. Through a busbar assembly of a battery module, a plurality of battery cells may be electrically connected. A battery cell may represent a minimum unit of a battery.

A busbar assembly may comprise an internal busbar that electrically connects battery cells inside a battery module and an external busbar that electrically connects an external device and an internal battery cell. An internal busbar and an external busbar may be connected to each other through welding. The material of a busbar may be selected in consideration of the cost, weight, and the like. The thickness of a busbar for satisfying target performance varies depending on the material of the busbar, which may affect welding. Accordingly, there is a need for a welding structure that is not affected by the thickness of a busbar.

### SUMMARY OF THE INVENTION

The purpose of the Examples of the present disclosure is to provide a busbar assembly to which a new form of welding structure is applied and a battery module including the same.

A busbar assembly according to an Example of the present disclosure may comprise a busbar plate electrically connected to electrode tabs of a plurality of battery cells; a busbar terminal electrically connected to an external device; and a welding portion electrically connecting the busbar plate and the busbar terminal with each other, wherein the welding portion may be formed by butt welding between the busbar plate and the busbar terminal.

In an Example, a welding portion may be formed by welding a boundary portion between a busbar plate and a busbar terminal in a state where the busbar plate and the busbar terminal are disposed to face each other.

In an Example, a busbar plate may comprise a supporting portion and a first plate connected to one side of the supporting portion, wherein a busbar terminal may comprise a connecting portion disposed on the supporting portion, and a welding portion may comprise a first welding portion formed between one side of the connecting portion and one side of the first plate.

In an Example, the thickness of a first plate may be greater than the thickness of a supporting portion.

In an Example, the thickness of the first plate may be the same as the sum of the thickness of a supporting portion and the thickness of a connecting portion.

In an Example, a plurality of holes into which electrode tabs of a plurality of battery cells are inserted may be formed on the first plate.

In an Example, a busbar terminal may further comprise a terminal lead connected to a connecting portion.

In an Example, a busbar plate may further comprise a second plate that is connected to another side of a supporting portion and that has a thickness greater than the thickness of the supporting portion, and a welding portion may further comprise a second welding portion formed between another side of a connecting portion and one side of a second plate.

In an Example, the busbar assembly may further comprise a busbar frame disposed between a plurality of battery cells and a busbar plate.

A battery module according to an Example of the present disclosure may comprise a plurality of battery cells stacked in one direction; and a busbar assembly comprising a busbar plate electrically connected to electrode tabs of at least two of a plurality of battery cells, a busbar terminal electrically connected to an external device, and a welding portion disposed in at least one boundary area among a plurality of boundary areas between the busbar plate and the busbar terminal.

In an Example, a welding portion may be formed by welding a boundary portion between a busbar plate and a busbar terminal in a state where the busbar plate and the busbar terminal are disposed to face each other.

In an Example, a busbar plate may comprise a supporting portion and a first plate connected to one side of the supporting portion; a busbar terminal may comprise a connecting portion disposed on the supporting portion; and a welding portion may comprise a first welding portion formed in a boundary area between one side of the connecting portion and one side of the first plate.

In an Example, the thickness of a first plate may be greater than the thickness of a supporting portion.

In an Example, the thickness of a first plate may be the same as the sum of the thickness of a supporting portion and the thickness of a connecting portion.

In an Example, at least two holes into which electrode tabs of at least two battery cells are inserted may be formed on a first plate.

In an Example, a busbar terminal may further comprise a terminal lead connected to a connecting portion.

In an Example, a busbar plate may further comprise a second plate that is connected to another side of a supporting portion and that has a thickness greater than the thickness of the supporting portion, and a welding portion may further comprise a second welding portion formed between another side of a connecting portion and one side of a second plate.

In an Example, the busbar assembly may further comprise a busbar frame disposed between at least two battery cells and a busbar plate.

An Example of the present disclosure may provide a busbar assembly to which a new type of welding structure is applied and a battery module including the same.

An Example of the present disclosure may increase the cross-sectional area of a current passage generated through welding.

An Example of the present disclosure may reduce thermal deformation of a busbar assembly due to welding.

An Example of the present disclosure may increase the degree of freedom in the design of the thickness or material of a busbar assembly.

### BRIEF DESCRIPTION OF THE DRAWINGS

FIG. 1A is a diagram for explaining a battery module according to an Example.

FIG. 1B is a diagram for explaining a busbar assembly according to an Example.

FIG. 2 is a diagram for explaining a battery cell according to an Example.

FIGS. 3A and 3B are diagrams for explaining a busbar according to an Example.

FIG. 4 is a diagram for explaining a configuration of a busbar according to an Example.

FIGS. 5A, 5B and 5C are diagrams for explaining a welding portion according to an Example.

FIG. 6 is a diagram for explaining a configuration of a busbar according to another Example.

FIGS. 7A, 7B and 7C are diagrams for explaining a welding portion according to another Example.

FIGS. 8A and 8B are diagrams for explaining the cross-section of a welding portion according to an Example.

### DETAILED DESCRIPTION

The structural or functional descriptions of Examples disclosed in the present specification or application are merely illustrated for the purpose of explaining Examples according to the technical principle of the present invention, and Examples according to the technical principle of the present invention may be implemented in various forms in addition to the Examples disclosed in the specification of application. In addition, the technical principle of the present invention is not construed as being limited to the Examples described in the present specification or application.

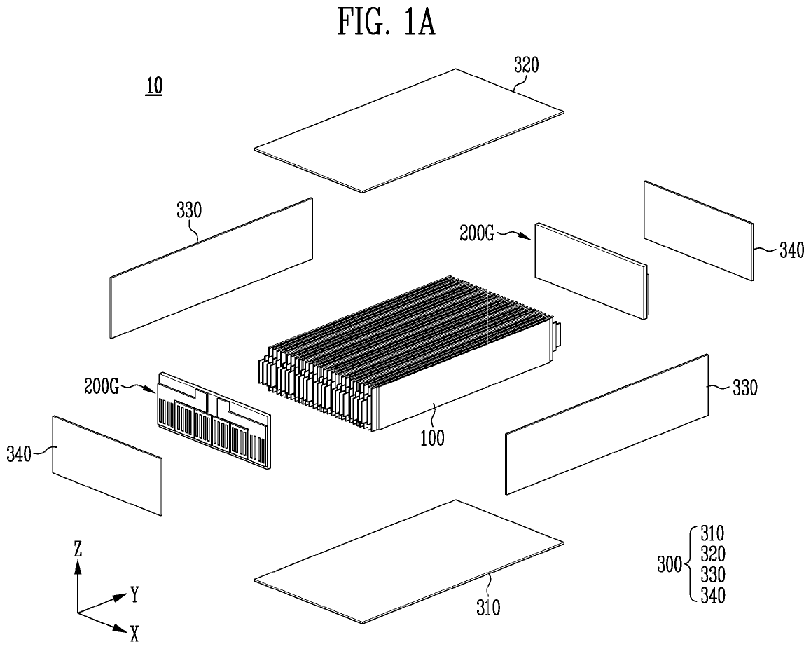

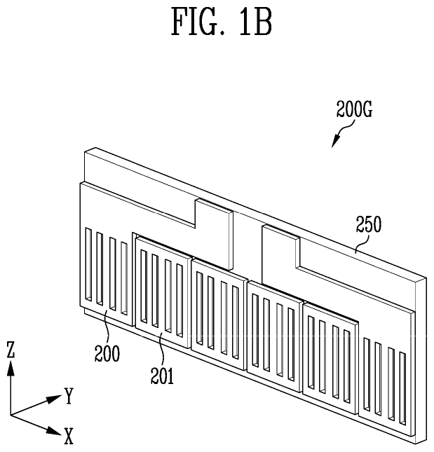

FIG. 1A is a diagram for explaining a battery module according to an Example.

Referring to FIG. 1A, a battery module 10 according to an Example may comprise a battery cell 100, a busbar assembly 200G, and a case 300.

A battery cell 100 may be a secondary battery capable of repeatedly being charged and discharged. The number of battery cells 100 may be plural. Battery cells 100 may be stacked in one direction. For example, battery cells 100 may be stacked in the X-axis direction.

A battery cell 100 may comprise an electrode assembly, an exterior material, and an electrode tab. An exterior material may cover an electrode assembly. An electrode and an electrode tab of an electrode assembly may be electrically connected by contacting each other. An electrode tab may be electrically connected to a busbar assembly 200G. An electrode tab may protrude in a direction different from the stacking direction of battery cells 100. For example, when the stacking direction is the X-axis direction, the electrode tab may protrude in the Y-axis direction.

The type of a battery cell 100 may be a pouch type. However, this is only an Example, and the type of a battery cell 100 may be modified into a cylindrical type, a prismatic type, and the like.

A busbar assembly 200G may be electrically connected to an electrode tab of a battery cell 100. To this end, a busbar assembly 200G and an electrode tab may be made of a conductor capable of conducting electricity for having high electrical conductivity. A case 300 may accommodate a battery cell 100. In an Example, a case 300 may comprise a lower case 310, an upper case 320, an end plate 330, and a side plate 340. A lower case 310 may be positioned below a battery cell 100. A lower case 310 may support a battery cell 100. An upper case 320 may be located on top of a battery cell 100. An end plate 330 may be located on one side of a battery cell 100. For example, when battery cells 100 are stacked in the X-axis direction, end plates 330 may be located at both ends in the X-axis direction with reference to a stack of battery cells 100. A side plate 340 may be located on the other side of a battery cell 100. For example, when battery cells 100 are stacked in the X-axis direction, side plates 340 may be positioned at both ends in the Y-axis direction with reference to a stack of battery cells 100.

In an Example, a lower case 310 may be manufactured as a component integrated with an end plate 330 or a side plate 340. In an Example, a lower case 310 may be manufactured as a separate component from an end plate 330 or a side plate 340. In this case, the lower case 310 may be coupled to the end plate 330 and the side plate 340 through fixing members such as bolts and clamps. Similarly, an upper case 320 may be manufactured as a component integrated with an end plate 330 or a side plate 340 or may be manufactured as a separate component. In an Example, at least one of an end plate 330 and a side plate 340 may be omitted.

FIG. 1B is a diagram for explaining a busbar assembly according to an Example.

Referring to FIG. 1B, a busbar assembly 200G according to an Example may comprise a plurality of busbars 200, 201.

A plurality of busbars 200, 201 may comprise a first busbar 200 and a second busbar 201. A first busbar 200 may electrically connect a battery cell 100 and an external device. A second busbar 201 may electrically connect a battery cell 100 included in a battery module 10 and another battery cell included in the battery module 10.

In an Example, a plurality of busbars 200, 201 may be manufactured as individual components. In another Example, a plurality of busbars 200, 201 may be manufactured as integrated components.

A busbar assembly 200G according to an Example may further comprise a busbar frame 250.

A plurality of busbars 200, 201 may be coupled to a busbar frame 250. A busbar frame 250 may fix the positions of a plurality of busbars 200, 201. In an Example, a busbar frame 250 may be made of various materials such as plastic and metal. A busbar frame 250 may be positioned between a plurality of busbars 200, 201 and a battery cell 100. Meanwhile, a hole into which an electrode tab of a battery cell 100 can be inserted may be formed on each of a plurality of busbars 200, 201 according to an Example. In addition, holes may be formed on a busbar frame 250 at positions corresponding to the positions of the holes on the busbars 200, 201.

In an Example, a first busbar 200 may be formed through welding. Therefore, among a first busbar 200 and a second busbar 201, only a first busbar 200 may be a subject of welding. However, this is only an Example, and a second busbar 201 may also be a subject of welding.

An Example of the present disclosure may provide a busbar assembly 200G to which a new type of welding structure is applied and a battery module 10 including the busbar assembly 200G. Hereinafter, Examples of the present disclosure will be described in more detail with reference to the accompanying drawings.

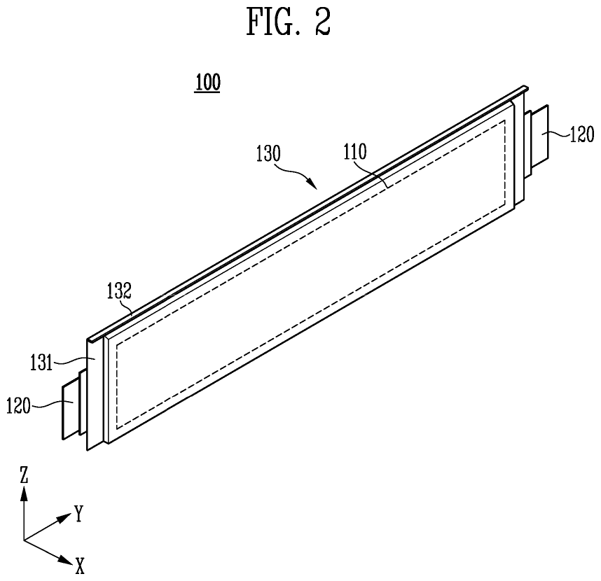

FIG. 2 is a diagram for explaining a battery cell according to an Example.

Referring to FIG. 2, another battery cell 100 according to an Example may comprise an electrode assembly 110, an electrode tab 120, and an exterior material 130. A battery cell battery cell 100 according to an Example may be a secondary battery of a pouch type. A pouch type may be a secondary battery using a material with a soft or flexible characteristic as an exterior material 130.

An electrode assembly 110 may comprise an electrode, a separator, and an electrolyte. An electrode may comprise an anode and a cathode. Anodes and cathodes may be laminated alternately. A separator may be disposed between an anode and a cathode.

A separator may block electrical contact between an anode and a cathode. A separator may have holes therein so that ions such as lithium ions can pass through. An electrolyte may comprise a material that functions as a medium that helps to the transport of ions such as lithium ions.

An electrode tab 120 may be connected to an electrode of an electrode assembly 110. Specifically, an electrode tab 120 may comprise a cathode tap that is electrically connected to a cathode of an electrode assembly 110 and an anode tab that is electrically connected to an anode of an electrode assembly 110. An electrode tab 120 may protrude to the outside of an exterior material 130. For example, a cathode tab may protrude in the +Y-axis direction, and an anode tab may protrude in the −Y-axis direction. In an Example, the materials of each of a cathode tab and an anode tab may be conductive materials such as copper and aluminum.

An exterior material 130 may cover an electrode assembly 110. For example, an electrode assembly 110 may be accommodated in an inner space formed by an exterior material 130. In an Example, an exterior material 130 may be a pouch-type film. For example, an exterior material 130 may be an aluminum laminate film. Accordingly, an exterior material 130 may protect an electrode assembly 110.

An exterior material 130 may comprise sealing portions 131, 132. Sealing portions 131, 132 may be formed by being joined in various ways such as adhesive, heating, and compressing. Sealing portions 131, 132 may comprise a first sealing portion 131 and a second sealing portion 132. A second sealing portion 132 may be a folded part in a first sealing portion 131.

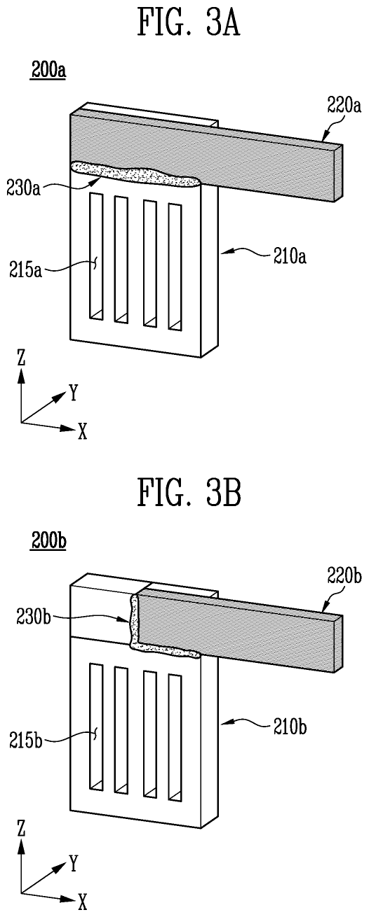

FIGS. 3A and 3B are diagrams for explaining a busbar according to an Example.

Referring to FIGS. 3A and 3B, busbars 200a, 200b may comprise busbar plates 210a, 210b, busbar terminals 220a, 220b, and welding portions 230a, 230b. Busbars 200a, 200b may have polarity of a cathode or an anode. Meanwhile, the busbars 200a, 200b of FIGS. 3A and 3B may be a first busbar 200 described in FIG. 1B, but is not limited thereto. The busbar 200b of FIGS. 3A and 3B may be a second busbar 201.

Busbar plates 210a, 210b may be electrically connected to a battery cell 100. Busbar plates 210a, 210b may electrically connect a battery cell 100 with another battery cell included in the same battery module 10.

In an Example, at least one hole 215a, 215b may be formed on a busbar plate 210a, 210b. A hole 215a, 215b may be a penetrated area on a busbar plate 210a, 210b. An electrode tab 120 of a battery cell 100 may be inserted into a hole 215a, 215b of a busbar plate 210a, 210b. For example, an electrode tab 120 may be inserted into a hole 215a, 215b and bent. A bent portion of an electrode tab 120 may be in contact with a surrounding area of a hole 215a, 215b on a busbar plate 210a, 210b. Through a contact area, a busbar plate 210a, 210b may be electrically connected to a battery cell 100. For example, in a state where an electrode tab 120 is inserted into a hole 215a, 215b and protrudes, an electrode tab 120 may be bonded by using laser welding and the like. In this case, the electrode tab 120 of the battery cell 100 may be in contact with a busbar plate 210a, 210b. Accordingly, the battery cell 100 may be electrically connected to the busbar plate 210a, 210b through the electrode tab 120.

In the same way, a busbar plate 210a, 210b may be electrically connected to another battery cell included in a battery module 10. Accordingly, a battery cell 100 may be electrically connected to another battery cell through a busbar plate 210a, 210b.

Busbar terminals 220a, 220b can be electrically connected to an external device. An external device represents an electronic device or an electrical device outside a battery module 10. For example, an external device may be another battery module, BMS (Battery Management System), a vehicle, and other electronic devices.

A busbar plate 210a, 210b and a busbar terminal 220a, 220b may each comprise at least one of conductive materials such as copper and aluminum. For example, a busbar plate 210a, 210b and a busbar terminals 220a, 220b may each consist of a core material containing copper, aluminum, or alloys thereof and a plating layer surrounding the core material. A plating layer may comprise a conductive material such as nickel, tin, gold, and silver.

A welding portion 230a, 230b may be formed through welding. Welding may be performed by applying various methods such as laser welding, electron beam welding, arc welding, and ultrasonic welding. A busbar plate 210a, 210b may be connected to a busbar terminal 220a, 220b via a welding portion 230a, 230b.

Welding portions 230a, 230b may be formed through butt welding (butt joint welding). Butt welding may be a method of welding boundaries of two base materials in a state where the base materials that are subject to welding face each other.

A welding portion 230a, 230b may be formed between a busbar plate 210a, 210b and a busbar terminal 220a, 220b. In other words, a welding portion 230a, 230b may be formed in a boundary portion of a busbar plate 210a, 210b and a busbar terminal 220a, 220b. A busbar plate 210a, 210b and a busbar terminal 220a, 220b may be electrically connected to each other through a welding portion 230a, 230b.

In an Example, busbar plates 210a, 210b and busbar terminals 220a, 220b may be arranged such that there are a plurality of boundary areas where the busbar plates 210a, 210b and the busbar terminals 220a, 220b face each other. In other words, a plurality of boundary areas may exist between busbar plates 210a, 210b and busbar terminals 220a, 220b. In this case, welding portions 230a, 230b may be disposed in at least one of the plurality of boundary areas.

For example, as shown in FIG. 3A, boundary areas between a busbar plate 210a and a busbar terminal 220a may comprise a boundary area corresponding to the XY-plane and a boundary area corresponding to the XZ-plane. In this case, a welding portion 230a may be disposed in the boundary area corresponding to the XY-plane. For example, as shown in FIG. 3B, boundary areas between a busbar plate 210b and a busbar terminal 220b may comprise a boundary area corresponding to the XY-plane, a boundary area corresponding to the XZ-plane, and a boundary area corresponding to the YZ-plane. In this case, a welding portion 230b may be disposed in the boundary area corresponding to the XY-plane and/or the boundary area corresponding to the YZ-plane.

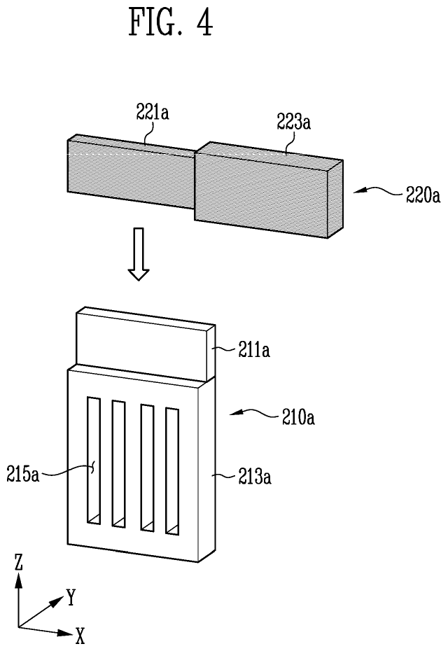

FIG. 4 is a diagram for explaining a configuration of a busbar according to an Example.

Referring to FIG. 4, a busbar plate 210a according to an Example may comprise a supporting portion 211a and a first plate 213a. A supporting portion 211a and a first plate 213a may be manufactured as an integrated component or may be manufactured as separate components.

A connecting portion 221a of a busbar terminal 220a may be seated on a supporting portion 211a. In this case, the supporting portion 211a may support the connecting portion 221a.

One side of a first plate 213a may be connected to one side of a supporting portion 211a. For example, one side of a first plate 213a and one side of a supporting portion 211a may be a flat surface that is perpendicular to the Z-axis direction.

In an Example, the thickness of a first plate 213a may be greater than the thickness of a supporting portion 211a. The thickness here may be the length in the Y-axis direction.

In an Example, the thickness of a first plate 213a may be the same as the sum of the thickness of a supporting portion 211a and the thickness of a connecting portion 221a. The thickness here may be the length in the Y-axis direction.

In an Example, at least one hole 215a may be formed on a first plate 213a. An electrode tab 120 of a battery cell 100 may be inserted into a hole 215a.

A busbar terminal 220a according to an Example may comprise a connecting portion 221a. A connecting portion 221a may be disposed on a supporting portion 211a.

In an Example, a busbar terminal 220a may further comprise a terminal lead 223a.

A terminal lead 223a may be connected to a connecting portion 221a. Specifically, one side of a connecting portion 221a and one side of a terminal lead 223a may be connected to each other. For example, one side of a connecting portion 221a and one side of a terminal lead 223a may be a flat surface that is perpendicular to the X-axis direction. In an Example, a connecting portion 221a and a terminal lead 223a may be manufactured as an integrated component or may be manufactured as separate components.

A terminal lead 223a can be electrically connected to an external device. To this end, a part of a terminal lead 223a may protrude outside a case 300 of a battery module 10.

According to an Example of the present disclosure, busbars 200a, 200b with a new type of welding structure and a battery module 10 comprising the same may be provided. In addition, an Example of the present disclosure may increase the degree of freedom in the design of the thickness or material of a busbar 200a, 200b.

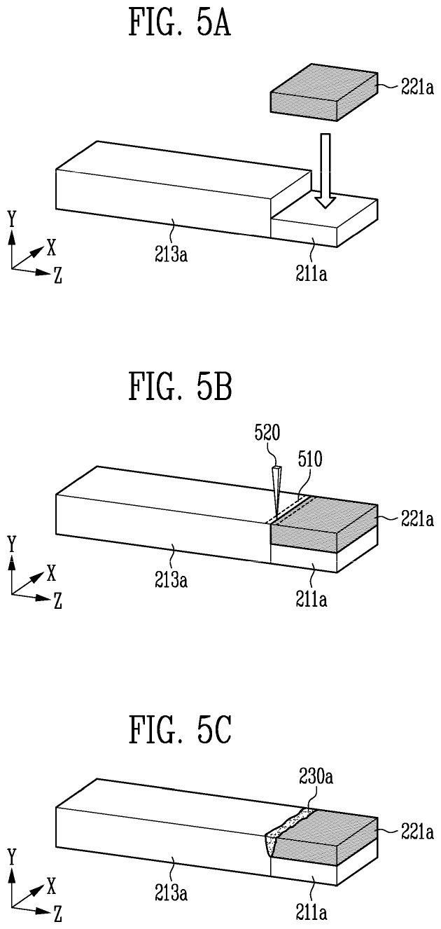

FIGS. 5A, 5B and 5C are diagrams for explaining a welding portion according to an Example. FIGS. 5A to 5C show a process in which a welding portion 230a is formed.

Referring to FIG. 5A, a connecting portion 221a may be disposed on a supporting portion 211a so that an upper surface of the supporting portion 211a and a lower surface of the connecting portion 221a may face each other. Here, the upper surface of the supporting portion 211a and the lower surface of the connecting portion 221a may each be a flat surface that is perpendicular to the Y-axis direction.

In this case, the connecting portion 221a may be disposed on the supporting portion 211a so that one side of the connecting portion 221a and one side of a first plate 213a may face each other. Here, one side of the connecting portion 221a and one side of the first plate 213a may each be a flat surface that is perpendicular to the Z-axis direction.

Referring to FIG. 5B, laser 520 may be irradiated to a boundary portion 510 of a connecting portion 221a and a first plate 213a. A boundary portion 510 may be an area that is spaced as much as a reference value from the centerline between one side of a connecting portion 221a and one side of a first plate 213a. A reference value may be preset at various values. For example, one side of a connecting portion 221a may be a side corresponding to the XY-plane that is in contact with a first plate 213a among the sides of the connecting portion 221a. For example, one side of a first plate 213a may be a side corresponding to the XY-plane that is in contact with a connecting portion 221a among the sides of the first plate 213a.

In an Example, in a state where a busbar plate 210a and a busbar terminal 220a are disposed to face each other, a boundary portion 510 of the busbar plate 210a and the busbar terminal 220a may be welded to form a welding portion 230a.

Referring to FIG. 5C, a welding portion 230a may be formed as a boundary portion 510 is welded in a state where one side of a connecting portion 221a and one side of a first plate 213a are disposed to face each other. In this case, a welding portion 230a may be formed between one side of the connecting portion 221a and one side of the first plate 213a. A welding portion 230a may be a welding bead that is formed as a boundary portion 510 is heated by laser and cooled.

In an Example, the thickness of a welding portion 230a may be the same as the thickness of a connecting portion 221a, or greater than the thickness of a connecting portion 221a. The thickness may be the length in the Y-axis direction, but this is only one Example. The thickness of a welding portion 230a may be smaller than the thickness of a connecting portion 221a.

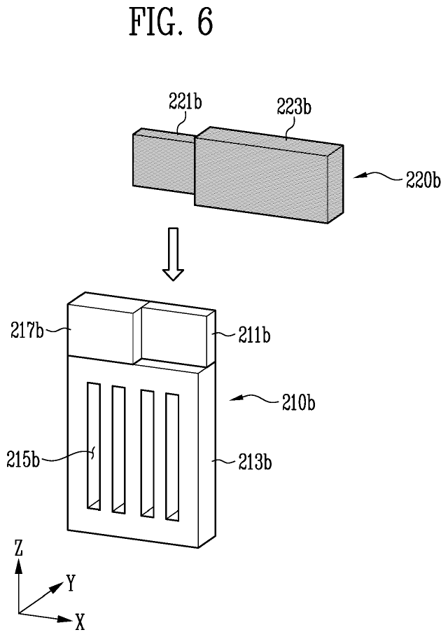

FIG. 6 is a diagram for explaining a configuration of a busbar according to another Example.

Referring to FIG. 6, a busbar plate 210b according to another Example may comprise a supporting portion 211b, a first plate 213b, and a second plate 217b. A supporting portion 211b, a first plate 213b, and a second plate 217b may be prepared as an integrated component, or may be prepared as separate components.

A connecting portion 221b of a busbar terminal 220b may be seated on a supporting portion 211b.

One side of a first plate 213b may be connected to one side of a supporting portion 211b. One side of a first plate 213b and one side of a supporting portion 211b may be a flat surface that is perpendicular to the Z-axis direction.

One side of a first plate 213b may be connected to one side of a second plate 217b. One side of a first plate 213b and one side of a second plate 217b may be a flat surface that is perpendicular to the Z-axis direction.

In an Example, the thickness of a first plate 213b may be greater than the thickness of a supporting portion 211b. Here, the thickness may be the length in the Y-axis direction. In an Example, the thickness of a first plate 213b may be the same as the sum of the thickness of a supporting portion 211b and the thickness of a connecting portion 221b.

In an Example, at least one hole 215b may be formed on a first plate 213b. An electrode tab 120 of a battery cell 100 may be inserted into a hole 215b.

A second plate 217b may be connected to another side of a supporting portion 211b. Specifically, another side of a second plate 217b may be connected to another side of a supporting portion 211b. For example, another side of a second plate 217b and another side of a supporting portion 211b may be a flat surface that is perpendicular to the X-axis direction.

In an Example, the thickness of a second plate 217b may be greater than the thickness of a connecting portion 221b. In an Example, the thickness of a second plate 217b may be the same as the thickness of a first plate 213b. Here, the thickness may be the length in the Y-axis direction.

A busbar terminal 220b according to an Example may comprise a connecting portion 221b. A connecting portion 221b may be disposed on a supporting portion 211b.

In an Example, a busbar terminal 220b may further comprise a terminal lead 223b.

A terminal lead 223b may be connected to a connecting portion 221b. Specifically, one side of a connecting portion 221b and one side of a terminal lead 223b may be connected to each other. For example, one side of a connecting portion 221b and one side of a terminal lead 223b may be a flat surface that is perpendicular to the X-axis direction. In an Example, a connecting portion 221b and a terminal lead 223b may be manufactured as an integral component or may be manufactured as separate components.

A terminal lead 223b may be electrically connected to an external device. To this end, a part of a terminal lead 223b may protrude outside a case 300 of a battery module 10.

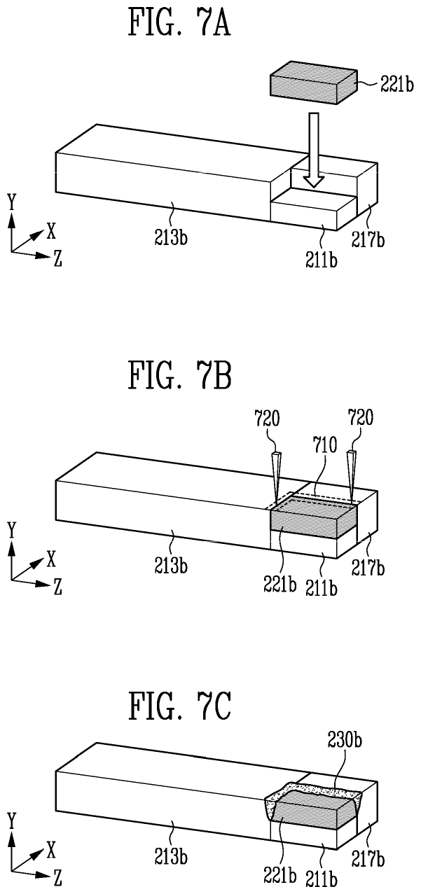

FIGS. 7A, 7B and 7C are diagrams for explaining a welding portion according to another Example. FIG. 7A shows a process in which a welding portion 230b is formed.

Referring to FIG. 7A, a connecting portion 221b may be disposed on a supporting portion 211b so that upper surface of the supporting portion 221b and a lower surface of the connecting portion 221b may face each other. Here, the upper surface of the supporting portion 211b and the lower surface of the connecting portion 221b may each be a flat surface that is perpendicular to the Y-axis direction.

In this case, the connecting portion 221b may be disposed on the supporting portion 211b so that one side of the connecting portion 221b and one side of a first plate 213b may face each other and another side of the connecting portion 221b and one side of a second plate 217b may face each other. Here, one side of the connecting portion 221b and one side of the first plate 213b may each be a flat surface that is perpendicular to the Z-axis direction. Another side of the connecting portion 221b and one side of the second plate 217b may each be a flat surface that is perpendicular to the X-axis direction.

Referring to FIG. 7B, laser 720 may be irradiated to a boundary portion 710. A boundary portion 710 may comprise a first boundary area between a connecting portion 221b and a first plate 213b and a second boundary area between a connecting portion 221b and a second plate 217b.

A first boundary area may be an area that is spaced as much as a reference value from the centerline between one side of a connecting portion 221b and one side of a first plate 213b. A second boundary area may be an area that is spaced as much as a reference value from the centerline between another side of the connecting portion 221b and one side of a second plate 217b. A reference value may be preset at various values.

Referring to FIG. 7C, a welding portion 230b may be formed as a boundary portion 710 is welded.

A welding portion 230b may comprise a first welding portion formed between one side of a connecting portion 221b and one side of a first plate 213b and a second welding portion formed between another side of the connecting portion 221b and one side of a second plate 217b. A welding portion 230b may be a welding bead that is formed as a boundary portion 710 is heated by laser and cooled.

In an Example, the thickness of a welding portion 230b may be the same as the thickness of a connecting portion 221b, or greater than the thickness of a connecting portion 221b. The thickness may be the length in the Y-axis direction, but this is only one Example. The thickness of a welding portion 230b may be smaller than the thickness of a connecting portion 221b.

According to an Example of the present disclosure, as a first welding portion and a second welding portion are formed in a direction that is perpendicular to each other, the thermal deformation of a busbar 200b by welding may be reduced.

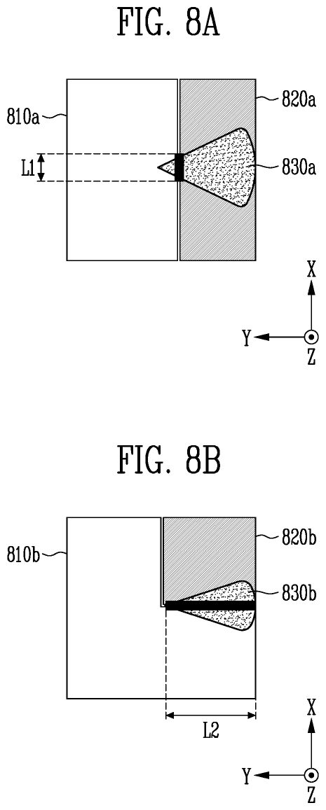

FIGS. 8A and 8B are diagrams for explaining the cross-section of a welding portion according to an Example.

FIG. 8A shows the cross-section of a welding portion 830a according to lap welding, and FIG. 8B shows the cross-section of a welding portion 830b according to butt welding.

Referring to FIG. 8A, a busbar terminal 820a may be welded in a state where a busbar terminal 820a is overlapped on a busbar plate 810a. In this case, along the thickness direction, the top of the busbar terminal 820a, the bottom of the busbar terminal 820a, and the top of the busbar plate 810a may be sequentially welded. The thickness direction may be the Y-axis direction.

In the case of lap welding, the welding direction may be perpendicular to a boundary surface (or boundary area) between a busbar plate 810a and a busbar terminal 820a. A boundary surface between a busbar plate 810a and a busbar terminal 820a may be the XZ-plane, and a welding direction may be the Y-axis direction. In other words, lap welding may be a method of indirectly welding a boundary surface between a busbar plate 810a and a busbar terminal 820a.

The cross-sectional length of a welding portion 830a formed through lap welding gradually decreases in the thickness direction. In particular, the cross-sectional length of a welding portion 830a formed in a boundary area between a lower end of a busbar terminal 820a and an upper end of a busbar plate 810a may be L1. Here, the cross-sectional length may be the length in the X-axis direction.

Referring to FIG. 8B, welding may be performed in a state where a busbar plate 810b and a busbar terminal 820b face each other. In this case, a boundary area between the busbar plate 810b and the busbar terminal 820b may be welded.

In the case of butt welding, the welding direction may be a relationship included in or a relationship parallel to a boundary surface (or boundary area) between a busbar plate 810b and a busbar terminal 820b. A boundary surface between a busbar plate 810b and a busbar terminal 820b may be the YZ-plane, and the welding direction may be the Y-axis direction. In other words, butt welding may be a method of directly welding a boundary surface between a busbar plate 810b and a busbar terminal 820b.

The cross-sectional length of a welding portion 830b formed in a boundary area between a busbar plate 810b and a busbar terminal 820b may be L2. Here, the cross-sectional length may be the length in the Y-axis direction.

Here, the cross-sectional length of a welding portion 830b formed through butt welding may be longer than the cross-sectional length of a welding portion 830a formed through lap welding. In other words, the cross-sectional area of a welding portion 830b formed through butt welding may be larger than the cross-sectional area of a welding portion 830a formed through lap welding. Here, a welding portion 830a, 830b may function as a current passage.

As described above, the cross-sectional area of a welding portion 830b according to the butt welding method provided in the present disclosure may be further increased compared to the lap welding method, thereby improving the current density.

What is claimed is:

1. A busbar assembly comprising: a busbar plate electrically connected to electrode tabs of a plurality of battery cells;
a busbar terminal electrically connected to an external device; and
a welding portion electrically connecting the busbar plate and the busbar terminal with each other,
wherein the welding portion is formed by butt welding between the busbar plate and the busbar terminal.

2. The busbar assembly according to claim 1, wherein the welding portion is formed by welding a boundary portion between a busbar plate and a busbar terminal in a state where the busbar plate and the busbar terminal are disposed to face each other.

3. The busbar assembly according to claim 1, wherein the busbar plate comprises a supporting portion and a first plate connected to one side of the supporting portion, wherein the busbar terminal comprises a connecting portion disposed on the supporting portion; and the welding portion comprises a first welding portion formed between one side of the connecting portion and one side of the first plate.

4. The busbar assembly according to claim 3, wherein the thickness of the first plate is greater than the thickness of the supporting portion.

5. The busbar assembly according to claim 3, wherein the thickness of the first plate is the same as the sum of the thickness of the supporting portion and the thickness of the connecting portion.

6. The busbar assembly according to claim 3, wherein a plurality of holes into which electrode tabs of the plurality of battery cells are inserted are formed on the first plate.

7. The busbar assembly according to claim 3, wherein the busbar terminal further comprises a terminal lead connected to the connecting portion.

8. The busbar assembly according to claim 3, wherein the busbar plate further comprises a second plate that is connected to another side of the supporting portion and that has a thickness greater than the thickness of the supporting portion, and the welding portion further comprises a second welding portion formed between another side of the connecting portion and one side of the second plate.

9. The busbar assembly according to claim 1, wherein the busbar assembly further comprises a busbar frame disposed between the plurality of battery cells and the busbar plate.

10. A battery module comprising:
a plurality of battery cells stacked in one direction; and
a busbar assembly comprising a busbar plate electrically connected to electrode tabs of at least two of the plurality of battery cells, a busbar terminal electrically connected to an external device, and a welding portion disposed in at least one boundary area among a plurality of boundary areas between the busbar plate and the busbar terminal.

11. The battery module according to claim 10, wherein the welding portion is formed by welding a boundary portion between the busbar plate and the busbar terminal in a state where the busbar plate and the busbar terminal are disposed to face each other.

12. The battery module according to claim 10, wherein the busbar plate comprises a supporting portion and a first plate connected to one side of the supporting portion, the busbar terminal comprises a connecting portion disposed on the supporting portion, and the welding portion comprises a first welding portion formed in a boundary area between one side of the connecting portion and one side of the first plate.

13. The battery module according to claim 12, wherein the thickness of the first plate may be greater than the thickness of the supporting portion.

14. The battery module according to claim 12, wherein the thickness of the first plate is the same as the sum of the thickness of the supporting portion and the thickness of the connecting portion.

15. The battery module according to claim 12, wherein at least two holes into which electrode tabs of the at least two battery cells are inserted are formed on the first plate.

16. The battery module according to claim 12, wherein the busbar terminal further comprises a terminal lead connected to the connecting portion.

17. The battery module according to claim 12, wherein the busbar plate further comprises a second plate that is connected to another side of the supporting portion and that has a thickness greater than the thickness of the supporting portion, and the welding portion further comprises a second welding portion formed between another side of the connecting portion and one side of the second plate.

18. The battery module according to claim 10, wherein the busbar assembly further comprises a busbar frame disposed between the at least two battery cells and the busbar plate.
